(19) United States
(12) Patent Application Publication
(10) Pub. No.: US 2020/0140067 A1
(43) Pub. Date: May 7, 2020

(54) SUPPORT FRAME, STAND ASSEMBLY, AND UNMANNED AERIAL VEHICLE

(71) Applicant: SZ DJI TECHNOLOGY CO., LTD., Shenzhen (CN)

(72) Inventors: Songquan MO, Shenzhen (CN); Luxin LI, Shenzhen (CN); Ben HU, Shenzhen (CN)

(21) Appl. No.: 16/715,440

(22) Filed: Dec. 16, 2019

Related U.S. Application Data
(63) Continuation of application No. PCT/CN2017/095252, filed on Jul. 31, 2017.

(30) Foreign Application Priority Data
Jun. 29, 2017 (CN) 201720773693.7

(51) Int. Cl. B64C 25/26; B64C 39/02; F16M 11/26

(52) U.S. Cl. CPC B64C 25/26; B64C 2201/187; F16M 11/26; B64C 39/024

(57) ABSTRACT

A support frame includes a locking assembly including a first locking frame and a locking block. The support frame also includes at least two support rods disposed on the first locking frame, the at least two support rods including at least one first support rod and at least one second support rod. The first locking frame is slidable relative to and along at least one of the support rods. The locking block is configured to be movable in a direction perpendicular to an axial direction of the second support rod and to press tightly on the second support rod, to lock the second support rod at a current location relative to an axial direction of the first support rod.

### CROSS-REFERENCE TO RELATED APPLICATIONS

This application is a continuation application of International Application No. PCT/CN2017/095252, filed on Jul. 31, 2017, which claims priority to Chinese Patent Application No. 201720773693.7, filed on Jun. 29, 2017, the entire contents of both of which are incorporated herein by reference.

### TECHNICAL FIELD

The present disclosure relates to the technology field of unmanned aerial vehicles (“UAV”) and, more particularly, to a support frame, a stand assembly, and a UAV.

### BACKGROUND

As the technologies continuously advance, smart devices such as UAVs have been widely used in people's daily life.

Currently, to support the UAV, a stand is generally provided at a lower portion of an aircraft body of the UAV. The stand may support the aircraft body of the UAV at a specific height away from the ground, to prevent direct contact between the aircraft body and the ground, and in the meantime, make it convenient to mount devices carried by the UAV, such as a camera, under the aircraft body.

However, as the UAVs are continuously made to be more and more portable, the height and the volume of the stand need to be reduced. However, when the UAV carries a relatively large device, due to the insufficient height of the stand, it may be necessary to replace an existing stand with a relatively longer stand.

### SUMMARY

According to an aspect of the present disclosure, a support frame is provided. The support frame includes a locking assembly including a first locking frame and a locking block. The support frame also includes at least two support rods disposed on the first locking frame, the at least two support rods including at least one first support rod and at least one second support rod. The first locking frame is slidable relative to and along at least one of the support rods. The locking block is configured to be movable in a direction perpendicular to an axial direction of the second support rod and to press tightly on the second support rod, to lock the second support rod at a current location relative to an axial direction of the first support rod.

According to another aspect of the present disclosure, a stand assembly for an unmanned aerial vehicle (“UAV”) is provided. The stand assembly includes a support base and a support frame including a locking assembly and at least two support rods. The locking assembly includes a first locking frame and a locking block. The at least two support rods are disposed on the first locking frame, and include at least one first support rod and at least one second support rod. The first locking frame is slidable along and relative to at least one of the support rods. The locking block is configured to be movable in a direction perpendicular to an axial direction of the second support rod, to lock the second support rod at a current location relative to an axial direction of the first support rod. At least one of the first support rod or the second support rod of the support frame is connected with the support base.

According to another aspect of the present disclosure, an unmanned aerial vehicle (“UAV”) is provided. The UAV includes an aircraft body and a stand assembly including a support base and a support frame. The support frame includes a locking assembly and at least two support rods. The locking assembly includes a first locking frame and a locking block. The at least two support rods are disposed on the first locking frame. The first locking frame is slidable along and relative to at least one of the support rods. The at least two support rods include at least one first support rod and at least one second support rod. The locking block is configured to be movable in a direction perpendicular to an axial direction of the second support rod and to press tightly on the second support rod, to lock the second support rod at a current location relative to an axial direction of the first support rod. At least one of the first support rod or the second support rod of the support frame is connected with the support base. In the stand assembly, the support rod not connected with the support base is connected with the aircraft body.

In the support frame, stand assembly, and UAV of the present disclosure, the support frame includes a locking assembly and at least two support rods. The locking assembly includes a first locking frame and a locking block. At least two support rods are disposed on the first locking frame. The first locking frame is slidable along and relative to at least one support rod. The at least two support rods include at least one first support rod and at least one second support rod. The locking block is movable along a direction perpendicular to an axial direction of the second support rod and can press tightly on the second support rod, to lock the second support rod at a current location relative to an axial direction of the first support rod. A length of such a support frame can change with the relative movement of the support rod, thereby adapting to different supporting and fixing scenes.

### BRIEF DESCRIPTION OF THE DRAWINGS

To more clearly describe the technical solutions of the various embodiments of the present disclosure or the existing technology, the accompanying drawings that are referred to in describing the embodiments or the existing technology will be briefly introduced. The accompanying drawings described below are some embodiments of the present disclosure. A person of ordinary skill in the art could derive other drawings based on the accompanying drawings without inventive efforts.

FIG. 1 is a schematic illustration of a structure of a support frame in a substantially extended state, according to an embodiment of the present disclosure;

FIG. 2 is a schematic illustration of a structure of a support frame in a substantially retracted state, according to an embodiment of the present disclosure;

FIG. 3 a schematic illustration of a structure of a support frame in a free adjustment state, according to an embodiment of the present disclosure;

FIG. 4 is an exploded view of a support frame, according to an embodiment of the present disclosure;

FIG. 5 is a schematic illustration of relative locations of a locking assembly and a support rod in the support frame, according to an embodiment of the present disclosure;

FIG. 6 is a schematic illustration of a locking assembly of the support frame, according to an embodiment of the present disclosure;

FIG. 7 is an exploded view of the locking assembly shown in FIG. 6, according to an embodiment of the present disclosure;

FIG. 8 is a schematic illustration of an adjustment stroke of the support frame in a substantially retracted state, according to an embodiment of the present disclosure;

FIG. 9 is a schematic illustration of an adjustment stroke of the support frame in a substantially extended state, according to an embodiment of the present disclosure;

FIG. 10 is a schematic illustration of a structure of an end portion of a second support rod of the support frame, according to an embodiment of the present disclosure;

FIG. 11 is a schematic illustration of an adjustment stroke the of the support frame in a substantially extended state, according to another embodiment of the present disclosure;

FIG. 12 is a schematic illustration of a connecting structure of another support frame, according to another embodiment of the present disclosure;

FIG. 13 is a schematic illustration of a structure of a stand assembly, according to another embodiment of the present disclosure;

FIG. 14 is a schematic illustration of a structure of the UAV when a stand assembly is in a substantially extended state, according to another embodiment of the present disclosure; and

FIG. 15 is a schematic illustration of a structure of the UAV when the stand assembly is in a substantially retracted state, according to another embodiment of the present disclosure.

### DESCRIPTIONS OF LABELS OF ACCOMPANY DRAWINGS

1—locking assembly;
2—support rod;
11—first locking frame;
12—locking block;
13—connecting member;
14—nylon sleeve tube;
15—second locking frame;
21, 21a, 21b—first locking rod;
22, 22a, 22b—second locking rod;
23—stopping member;
111—through hole of first locking frame;
112—arc shaped splint;
113—thread adjusting member;
114—through groove;
131—screw;
132—protrusion portion;
151—through hole of second locking frame;
100—support frame;
101—support base;
200—stand assembly;
201—aircraft body;
300—UAV;
1121—adjustment through hole;
12a—arc shaped surface.

### DETAILED DESCRIPTION OF THE EMBODIMENTS

In order to make the objective of the embodiments of the present disclosure, the technical solutions, and the advantages clearer, the technical solution of the of the embodiments of the present disclosure will be described in detail with reference to the accompanying drawings. The described embodiments are only some embodiments of the present disclosure, but are not all of the embodiments. Based on the embodiments of the present disclosure, all of other embodiments obtained by a person having ordinary skills in the art without creative efforts fall within the scope of protection of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationship.

A person having ordinary skill in the art can appreciate that when the term “and/or” is used, the term describes a relationship between related items. The term “A and/or B” means any combinations between the related items A and B. For example, A and/or B can mean A only, A and B, and B only. The symbol “/” means “or” between the related items separated by the symbol. The phrase “at least one of A, B, or C” encompasses all combinations of A, B, and C, such as A only, B only, C only, A and B, B and C, A and C, and A, B, and C. The term “and/or” may be interpreted as “at least one of.”

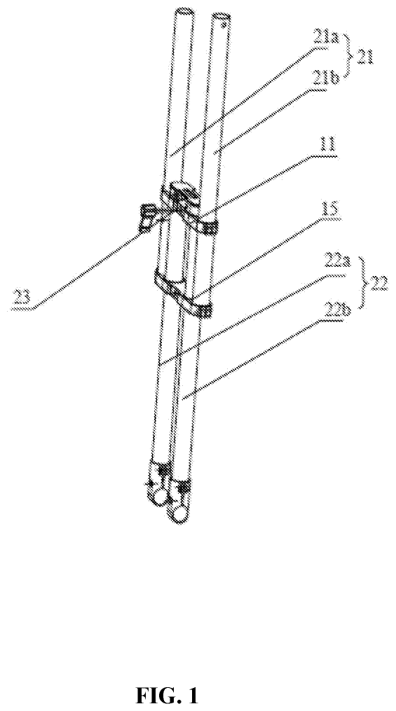

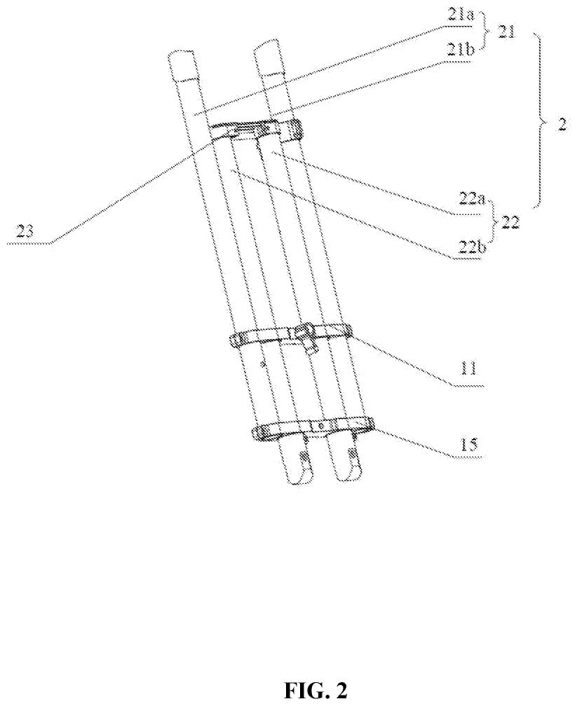

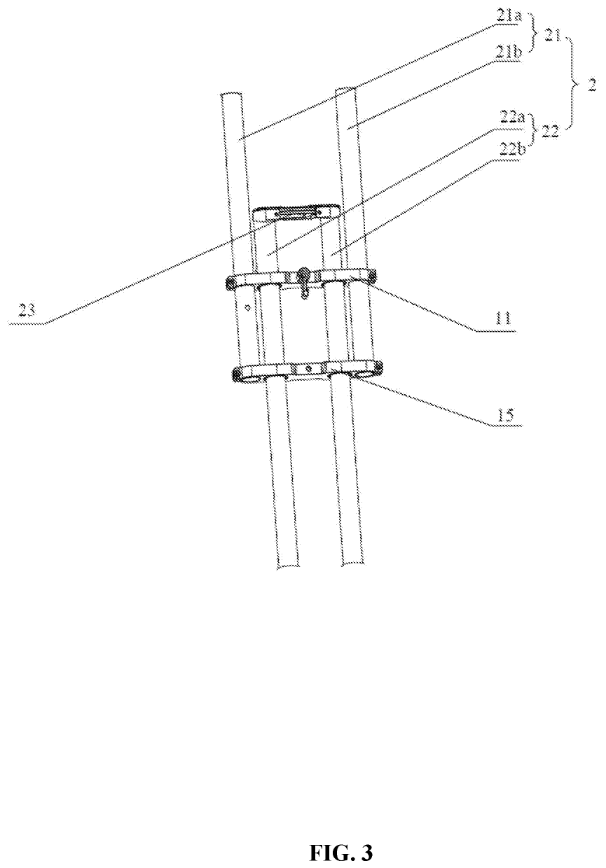

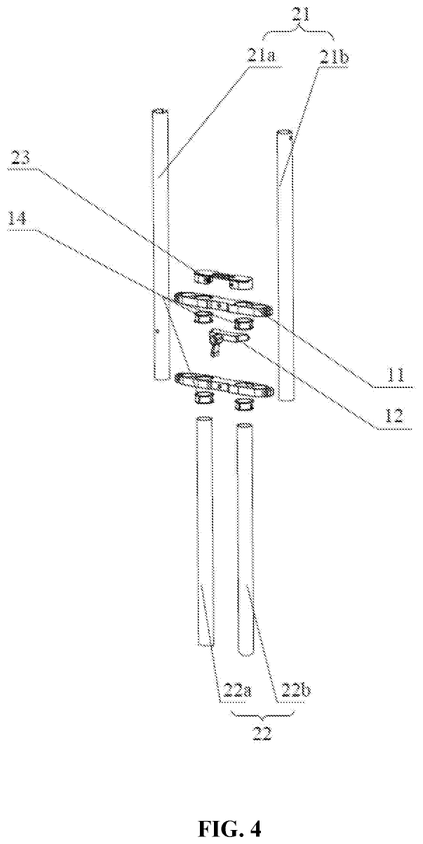

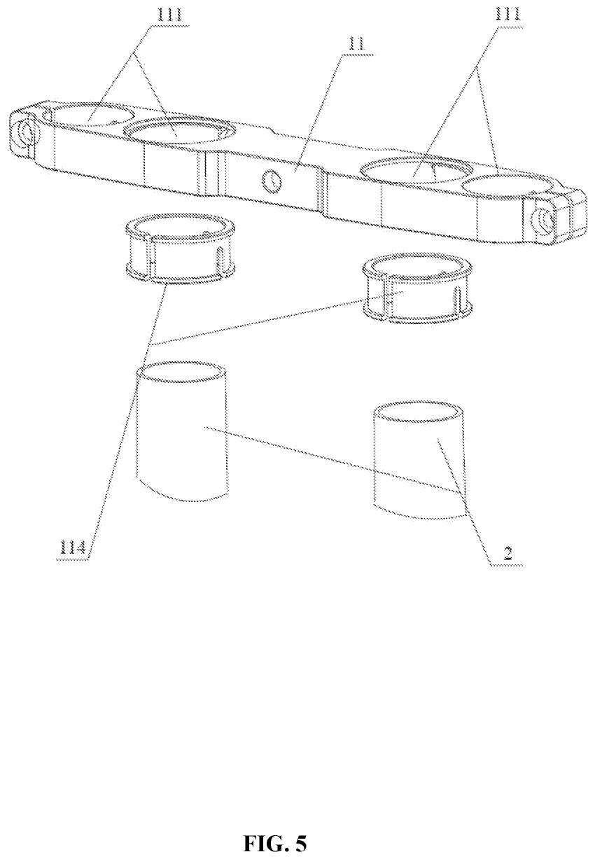

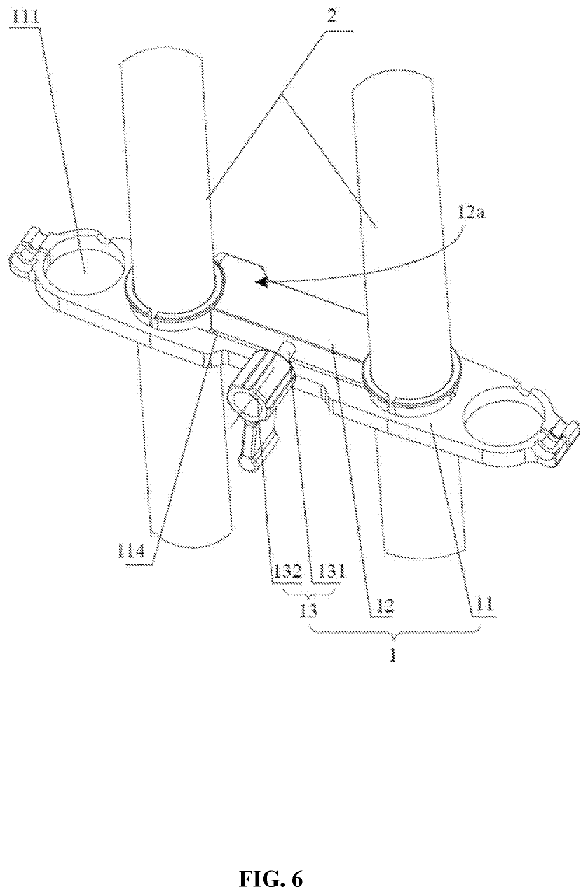

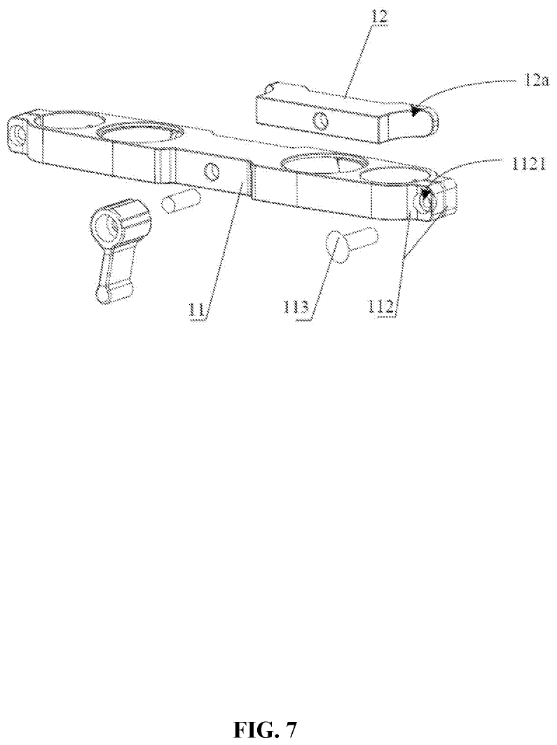

FIG. 1 is a schematic illustration of a structure of a support frame in a substantially extended state, according to an embodiment of the present disclosure. FIG. 2 is a schematic illustration of a structure of the support frame in a substantially retracted state according to an embodiment of the present disclosure. FIG. 3 is a schematic illustration of a structure of the support frame in a free adjustment state according to an embodiment of the present disclosure. FIG. 4 is a schematic exploded view of the support frame according to an embodiment of the present disclosure. FIG. 5 is a schematic illustration of relative locations of a locking assembly and a support rod of the support frame, according to an embodiment of the present disclosure. FIG. 6 is a schematic illustration of a structure of the locking assembly of the support frame according to an embodiment of the present disclosure. FIG. 7 is a schematic exploded view of the locking assembly shown in FIG. 6. As shown in FIG. 1 to FIG. 7, the support frame of the present disclosure may include a locking assembly 1 and at least two support rods 2. The locking assembly 1 may include a first locking frame 11 and a locking block 12. At least two support rods 2 may be disposed on the first locking frame 11. The first locking frame 11 may be slidable along and relative to at least one support rod 2. The at least two support rods 2 may include at least one first support rod 21 and at least one second support rod 22. The locking block 12 may be configured to be movable along a direction perpendicular to an axial direction of the second support rod 22 and to press tightly on the second support rod 22, to lock the support rod 22 at a current location relative to an axial direction of the first support rod 21.

In some embodiments, the support frame provided by the present disclosure may be implemented on a UAV, to realize a connection between an aircraft frame of the UAV and a landing stand, or other scenes where support and fixing is needed. The support rod 2 in the support frame may be made of a material having structure that is relatively light and a structural strength of which is relatively high, such as carbon fiber, which can be used to connect with different structures respectively. For example, when the support frame is implemented as a connection between the aircraft frame and the landing stand of the UAV, the first support rod 21 of the at least two support rods may be connected with the aircraft frame of the UAV, whereas the second support rod 22 may be connected with the landing stand of the UAV. Because the first locking frame 11 is configured to be slidable relative to and along at least one support rod, between the first support rod 21 and the second support rod 22, there are relatively movable axial locations due to a change in the relative locations between the first support rod 21 and the second support rod 22 and the first locking frame 11. As such, through location adjustment of different support rods along the axial direction, the change in the overall length of the support frame can be realized. To provide the maximum adjustable length of the support frame, the support rods may maintain parallel to one another.

In some embodiments, the connection between the first locking frame 11 and the second support rod 22 may be a slidable connection, whereas the connection between the first locking frame 11 and the first support rod 21 may be either a slidable connection, or a fixed connection in which the relative locations are fixed.

To realize the relative sliding between the first locking frame 11 and the support rod 2, the first locking frame 11 may be provided with at least one through hole 111. The support rod that can relatively slide penetrates these through holes 111, and the rod body of the support rod can slide relative to inner walls of these through holes 111. Because the facing directions of the through holes 111 are substantially the same, the slidable support rods are also arranged in parallel locations. In other words, the axial directions of the support rods are disposed in parallel.

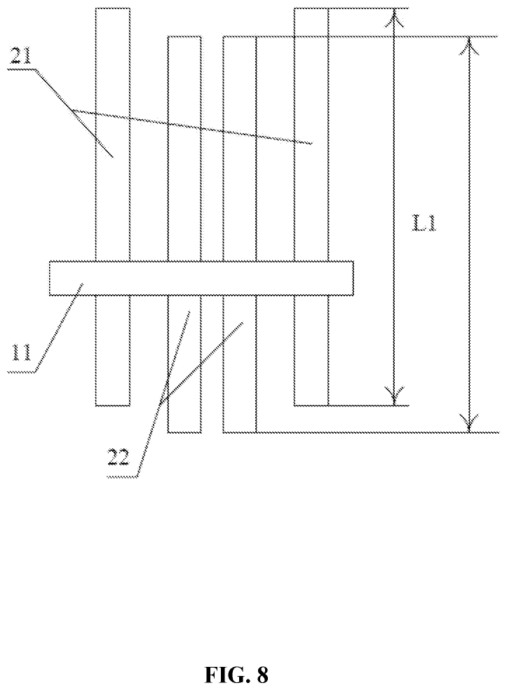

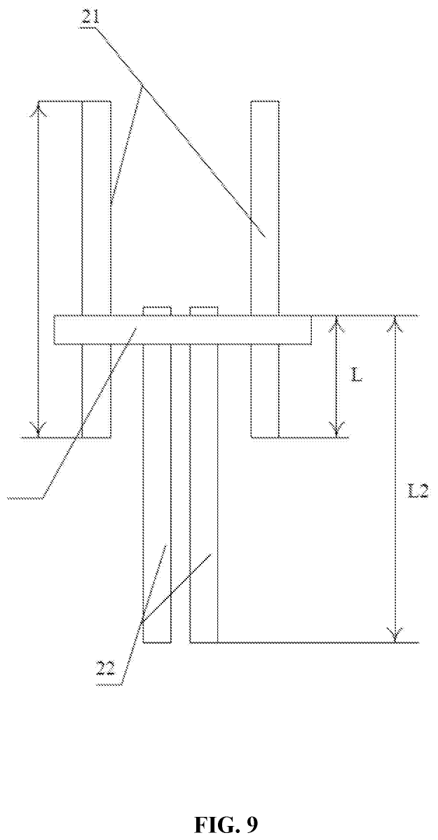

In some embodiments, the first locking frame 11 may be slidable relative to all support rods 2. In some embodiments, the first locking frame 11 may be fixed relative to the first support rod 21, and the second support rod 22 may be slidable inside and relative to the first locking frame 11, thereby changing its axial location relative to the first locking frame 11. In this embodiment, the first locking frame 11 being relatively fixed relative to the first support rod 21, and being slidable relative to the second support rod 22 is used as an example for descriptive purposes. In this embodiment, if the overall length of the support frame is to be adjusted, only the location of the second support rod 22 relative to the first locking frame 11 needs to be adjusted. FIG. 8 is a schematic illustration of an adjustment stroke of the support frame in a substantially retracted state according to an embodiment of the present disclosure. FIG. 9 is a schematic illustration of an adjustment stroke of the support frame in a substantially extended state according to an embodiment of the present disclosure. As shown in FIG. 8 and FIG. 9, a length of the first support rod 21 of the support frame may be L1, a length of the second support rod 22 may be L2, a distance between the first locking frame 11 and an end of the first support rod 21 may be L. The height of the support frame in the substantially retracted state may be a larger value of L1 and L2, and the height of the support frame in the substantially extended state may be approximately L1+L2−L.

In some embodiments, the first locking frame 11 may realize the fixed connection with the first support rod 21 through various fixed connection configurations. For example, the first locking frame 11 and the first support rod 21 may form an integral structure, or may be fixed together through a threaded connection or a snap-fit connection. In one embodiment, for the convenience of detaching, the first locking frame 11 may be coupled to the first support rod 21 via a through hole having a variable diameter. In some embodiments, the first locking frame 11 may include two arc shaped splints 112 that are symmetrically disposed and a thread adjusting member 113. A wall of the through hole corresponding to the first support rod 21 may be formed by the two arc shaped splints 112 combined together. The two arc shaped splints 112 may both include adjustment through holes 1121 matching with the thread adjusting member 113. The thread adjusting member 113 may penetrate the adjustment through hole 1121, and may be configured to adjust the distance between the two arc shaped splints 112. When the distance between the two arc shaped splints 112 changes, the first locking frame 11 can securely fix to the first support rod 21.

To realize the slidable connection between the first locking frame 11 and the second support rod 22, the first locking frame 11 may include at least one through hole 111. The second support rod 22 may correspond to the through hole 111 one on one, and may penetrate the through hole 111. As such, the slidable connection between the second support rod 22 and the first locking frame 11 can be maintained. Because the support frame is configured to bear a force, while maintaining the relative sliding between the second support rod 22 and the first locking frame 11, the second support rod 22 may be fixable at any location of the first locking frame 11 in the axial direction, such that the entire support frame becomes a rigid structure that can bear a force. To realize the relative positioning between the second support rod 22 and the first locking frame 11 in the axial direction, the first locking frame 11 may be provided with a locking block 12. The locking block 12 may be movable in a cross-sectional direction of the through hole 111 that corresponds to the second support rod 22. The locking block 12 may tightly press on the second support rod 22. Through the frictional force between the locking block 12 and the second support rod 22, the second support rod 22 may be locked at a current location relative to the first locking frame 11, i.e., the current location of the second support rod 22 relative to an axial direction of the first support rod 21. It should be noted that because the locking block 12 is configured to press tightly on the second support rod 22 and rely on the frictional force to resist the relative sliding between the second support rod 22 and the first locking frame 11, the locking block 12 and the second support rod 22 may not directly contact each other, but rather may be connected through other structure or material having a relatively low hardness, which may avoid the occurrence of the locking block 12 scratching the rod body of the second support rod 22.

To set the locking block 12, a through groove 114 may be provided on a wall of the through hole of the first locking frame 11 that corresponds to the second support rod 22. A dimension of an opening of the through groove 114 may be slightly larger than that of the locking block 12, thereby allowing the locking block 12 to insert into the through groove 114, and to translate substantially in the opening direction of the through groove 114. As such, by controlling the facing direction and dimension of the through groove 114, the locking block 12 may be movable in the cross-sectional direction of the through hole 111 relative to the first locking frame 11, so as to abut on the second support rod 22 or to disengage from the rod body of the second support rod 22. In addition, the locking block 12 can lock tightly at at least one location in the cross-sectional direction of the through hole 111. As such, when the locking block 12 presses tightly on the second support rod 22, the locking block 12 and the wall of the through hole 111 opposite the through groove 114 together sandwich or clamp the second support rod 22 in between, and tightly lock to fix at this location, so as to tightly press the second support rod 22 at the current location in the axial direction.

In addition, the support frame may also include a nylon sleeve tube 14 having a variable diameter. The nylon sleeve tube 14 may be disposed in the through hole 111 of the second support rod 22, and the locking block 12 may tightly press the outer side of the nylon sleeve tube 14, so as to tightly press the second support rod 22 at the current location in the axial direction. Because the material of the nylon sleeve tube 14 is relatively soft, and has a relatively strong wear resistance, the nylon sleeve tube 14 can therefore sleeve-fit an outer side of the second support rod 22 having different rod diameters, and realize a buffer between the second support rod 22 and the through hole 111, thereby avoiding the occurrence of the locking block 12 or the wall of the through hole of the first locking frame 11 scratching the external surface or the painted surface of the rod body of the second support rod 22. In some embodiments, the length of the nylon sleeve tube 14 may match with the depth of the through hole 111, thereby avoiding the occurrence of the nylon sleeve tube 14 being exposed out of the through hole 111 of the first locking frame 11 to affect the aesthetics. In addition, the opening of the nylon sleeve tube 14 may be provided with a positioning structure such as a protruding ring to stop the nylon sleeve tube 14 from sliding out of the through hole 111.

To increase the grasping force of the locking block 12 and the wall of the through hole 111 applied to the second support rod 22, and avoid the sliding of the second support rod 22 due to an insufficient pressing force of the locking block 12, the locking block 12 may include an arc shaped surface 12a that may match with the shape of the rod body of the second support rod 22. As such, the arc shaped surface 12a of the locking block 12 may closely fit with the second support rod 22, thereby increasing the contact area between the locking block 12 and the second support rod 22, which may increase the frictional force of the locking block 12 relative to the second support rod 22 to avoid sliding of the second support rod 22 due to an overly large axial force. In the meantime, the arc shaped surface 12a can assist in limiting the position of the second support rod 22, and reducing the movement of the second support rod 22 in the direction perpendicular to the axial direction. It should be noted that the radian of the arc shaped surface 12a may be larger than the radian of the rod body of the second support rod 22, to facilitate that the arc shaped surface 12a at least partially closely fits with the second support rod 22. In the meantime, supporting rods having different rod diameters are allowed to be used interchangeably.

In some embodiments, in order to realize the locking block 12 tightly locking at one or multiple locations in a direction perpendicular to the axial direction of the second support rod 22, i.e., the cross-sectional direction of the through hole 111 of the first locking frame 11, as an exemplary tight locking configuration, the locking assembly 2 may include a connecting member 13. The connecting member 13 may be configured to connect between the locking block 12 and the first locking frame 11. The connecting member 13 may be movable in the cross-sectional direction of the through hole 111 relative to the first locking frame 11, and may lock at at least one location in the cross-sectional direction of the through hole 111. The connecting member 13 may be configured to cause the locking block 12 to move in the cross-sectional direction of the through hole 111 and to lock tightly.

In some embodiments, the connecting member 13 may be multiple types of different connecting members and tight locking structures, as long as the connecting member 13 can tightly lock at one or multiple locations in the cross-sectional direction of the through hole 111 of the first locking frame 11. For example, tight locking may be realized through a cam tight locking mechanism. Because the cam tight locking mechanism can realize tight locking of a specific location, the locking block 12 may tightly lock at a relative location of the first locking frame 11, for example, a location the locking block 12 tightly presses on the second support rod 22. In some embodiments, the tight locking of the locking block 12 may be realized through a thread tight locking mechanism, in which, threads may be rotated to drive the locking block 12 to move forward or retract backward, to cause the location of the locking block 12 relative to the second support rod 22 in the cross-sectional direction of the through hole 111 to change. Because the thread tight locking mechanism has a self-locking capability, the locking block 12 can lock at any location in the cross-sectional direction of the through hole 111. As such, tight locking can be realized for multiple types of second support rods 22 having different rod diameters.

Using the connecting member 13 being a thread tight locking mechanism as an example for descriptive purpose: here, the connecting member 13 may include a screw 131 and a protrusion portion 132. The locking block 12 and the first locking frame 11 both may have a through hole matching with the screw 131. One of the through hole of the locking block 12 and the through hole of the first locking frame 11 may be a threaded hole, the other one may be a smooth hole without threads. The screw may penetrate the through holes of the locking block 12 and the first locking frame 11, and may be connected with the threads of the threaded hole. The protrusion portion 132 may abut against the smooth hole of the through hole of the locking block 12 or the first locking frame 11. As such, a user can, by handholding the protrusion portion 132 to rotate the screw 131, cause the locking block 12 to move forward or retract backward in an axial direction of the screw 131 under the rotational movement of the threads. When the locking block 12 contacts the second support rod 22 and presses tightly on the second support rod 22, the protrusion portion 132 can be released. At this moment, the location of the locking block 12 relative to the first locking frame 11 may be locked through the thread connection between the screw 131 and the threaded hole.

In some embodiments, the location of the threaded hole may be set based on the location of the protrusion portion 132 and the locking block 12 relative to the first locking frame 11. For example, when the protrusion portion 132 and the locking block 12 are located at different sides of the first locking frame 11, the through hole of the locking block 12 may be a threaded hole, and the through hole on the first locking frame 11 may be a smooth hole. Then, the protrusion portion 132 may abut against the first locking frame 11, to fix the relative locations between the screw 131 and the first locking frame 11, and to cause the locking block 12 to move back and forth in the axial direction of the screw 131 through the thread connection between the locking block 12 and the screw 131; or when the locking block 12 and the protrusion portion 132 are located at the same side of the first locking frame 11, the through hole of the locking block 12 may be a smooth hole, and the through hole on the first locking frame 11 may be a threaded hole. As such, the protrusion portion 132 may abut against the locking block 12, and may move back and forth relative to the first locking frame 11 through the thread connection between the screw 131 and the first locking frame 11, to cause the locking block 12 to move synchronously.

In some embodiments, the protrusion portion 132 of the connecting member 13 may be a structure that is convenient for a user to handhold and operate, such as a hand wheel, or a joystick, etc., in order to increase the convenience and the ease of use of adjusting the length of the support frame.

In addition, as an optional configuration, because the support of the first locking frame 11 for the support rod 2 in the axial direction of the support rod 2 is approximately a single point support, if the depth of the through hole on the first locking frame 11 for penetrating the support rod 2 is shallow, shaking or swing of the support rod 2 may occur in the through hole in the axial direction. To avoid this phenomenon, it may be desirable to provide assisted guiding to the support rod 2. To realize the assisted guiding for the support rod 2, the support frame may also include a second locking frame 15. The second locking frame 15 may be provided with at least one through hole 151. One of the first support rod 21 and the second support rod 22 may be fixedly connected with the second locking frame 15. Another one of the first support rod 21 and the second support rod 22 may be slidably connected with the second locking frame 15 through the through hole 151. In some embodiments, referring to FIG. 1 to FIG. 4, as an example structure, the first support rod 21 and the second locking frame 15 are fixedly connected, and the second support rod 22 is relatively slidably connected with the second locking frame 15 through the through hole 151. In some embodiments, the fixed connection method between the first support rod 21 and the second locking frame 15 may be a fixed connection between an end portion of the first support rod 21 and the corresponding through hole. As such the second locking frame 15 and the first locking frame 11 may be respectively disposed at different locations in the axial direction of the support rod 2, and may support and limit the position of the relatively slidable support rod through structures such as the through hole. Because the support rod 2 is guided and position-limited by the through hole at different locations in the axial direction of itself, the location of the support rod 2 relative to the axial direction of the through hole may be fixed, resulting in a relatively strong structural stability and reliability of the support frame.

In some embodiments, the fixed connection configuration between the second locking frame 15 and the first support rod 21 may likewise have multiple fixed connection configurations. For example, arc shaped splints and a thread adjusting member may be combined to form a through hole having an adjustable diameter, and the first support rod 21 may penetrate the through hole, thereby realizing a detachable connection. The detailed fixed connection configuration may be similar to the fixed connection configuration between the first locking frame 11 and the second support rod 21, which is not repeated.

When the support frame provides support and fixing, a single support rod may rotate relative to the first locking frame 11, or may be damaged due to insufficient structural strength of itself. These may affect the support stability of the support frame. To provide structural stability, the quantity of the first support rod 21 and the second support rod 22 in the support rod 2 may both be more than one. For example, in some embodiments, there may be four support rods 2. The four support rods 2 may include two first support rods 21a, 21b and two second support rods 22a, 22b. As such when the diameters of the first support rods 21a, 21b and the second support rods 22a, 22b are fixed, because the quantity of the support rods is increased, the overall structural strength of the support frame can be increased, enhancing the load bearing capacity of the support frame; in the meantime, two different first support rods 21a, 21b or two second support rods 22a, 22b may operate in concert, which may also avoid the occurrence of rotation when a single support rod is fixed, thereby increasing the overall reliability of the support frame. In some embodiments, to fix the support rods, the first locking frame 11 may be provided with four parallel through holes 111, to allow four different support rods 2 to penetrate therethrough.

Further, in order to realize the tight pressing and locking of the locking block 12 to the second support rod 22 when the support frame includes multiple support rods, two second support rods 22a and 22b may be disposed between two first support rods 21a, 21b. In some embodiments, two through holes adjacent an inner side of the first locking frame 11 may be configured to allow the second support rods 22a and 22b to penetrate therethrough, whereas two through holes located at an outer side may be configured to allow the first support rods 21a and 21b to penetrate therethrough. The through groove 114 on the first locking frame 11 may transverse the two through holes that allow the second support rods 22a and 22b to penetrate therethrough. The locking block 12 may include two grasping members or grasping surfaces having two different facing directions and may be respectively configured to tightly grasp different second support rods. In some embodiments, the through groove 114 and the locking block 12 may both be symmetrical structures, which may provide tight grasping of two second support rods 22a and 22b simultaneously.

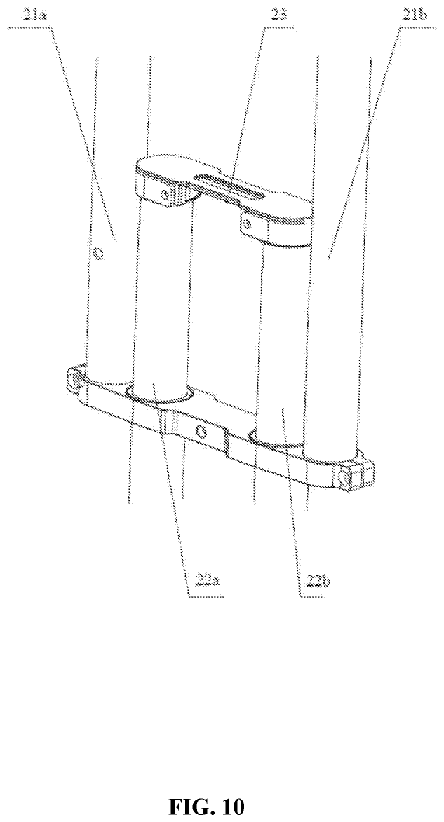

In order to limit the position of the second support rods 22a and 22b, avoiding the separation of the second support rods 22a and 22b from the through hole 111 of the first locking frame 11, the position of the second support rod may be limited through a stopping structure such as a stopping member. FIG. 10 is a schematic illustration of a structure of an end portion of the second support rod of the support frame, according to an embodiment of the present disclosure. As shown in FIG. 1 to FIG. 10, specifically, a stopping member 23 may be provided between end portions of the two second support rods 22a and 22b to abut against the first locking frame 11. As a realization configuration having a simple structure, the stopping member 23 may include two tube covers respectively sleeve-fit onto the end portions of the different second support rods 22a or 22b, and a connecting rib connecting the two tube covers. The stopping member 23 may be a metal stopping member which may increase the structural strength and the stopping reliability.

In addition, when the quantity of the support rods 2 is greater than four, the arrangement of the multiple support rods is similar to the situation when there are four support rods, which is not repeated.

In some embodiments, the quantity of the first support rods 21 and the second support rods 22 in the multiple support rods may be the same or different, and the quantity of the first support rods 21 and the quantity of the second support rods 22 may both be an odd number or an even number, which may adapt to different application scenes and needs.

In some embodiments, the support frame may include a locking assembly and at least two support rods. The locking assembly may include a first locking frame and a locking block. The at least two support rods may be disposed on the first locking frame. The first locking frame may slide relative to and along at least one support rod. The at least two support rods may include at least one first support rod and at least one second support rod. The locking block may be configured to be movable in a direction perpendicular to the axial direction of the second support rod and to press tightly on the second support rod, in order to lock the second support rod at the current location of relative to the axial direction of the first support rod. As such, the length of the support frame may change with the relative movement of the support rod, thereby adapting to different supporting and fixing scenes.

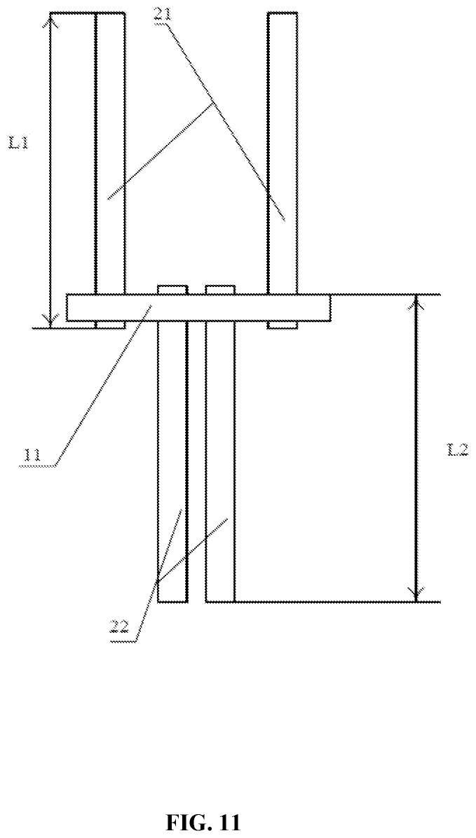

In addition, the first support rod 21 of the support frame may also be slidably connected with the first locking frame 11. FIG. 11 is a schematic illustration of an adjustment stroke of the support frame in a completely extended state according to another embodiment of the present disclosure. As shown in FIG. 11, because the first support rod 21 and the first locking frame 11 may be slidably connected, the adjustable stroke of the support frame is larger compared to the first embodiment. For example, the length of the first support rod may be L1, the length of the second support rod may be L2, then the maximum height of the support frame may be L1+L2, and the minimum height of the support frame may still be consistent with the minimum height of the first embodiment, as shown in FIG. 8. Therefore, the connection that allows for relative sliding between the first support rod 21 and the first locking frame 11 may increase the adjustable stroke of the support frame, adapting to different application scenes.

In some embodiments, in order to realize the relative sliding between the first support rod 21 and the first locking frame 11, the first locking frame 11 may be provided with at least two through holes having the same facing directions. The first support rod 21 and the second support rod 22 may both correspond to the through holes 111 one on one and may penetrate the through holes, and may realize relative sliding relative to the through holes, thereby realizing the relative sliding and adjustment relative to the first locking frame 11.

In some embodiments, the first support rod 21 and the second support rod 22 of the support frame may both maintain relative sliding with the first locking frame 11, therefore may provide a larger adjustment stroke for the support frame, thereby adapting to more application scenes.

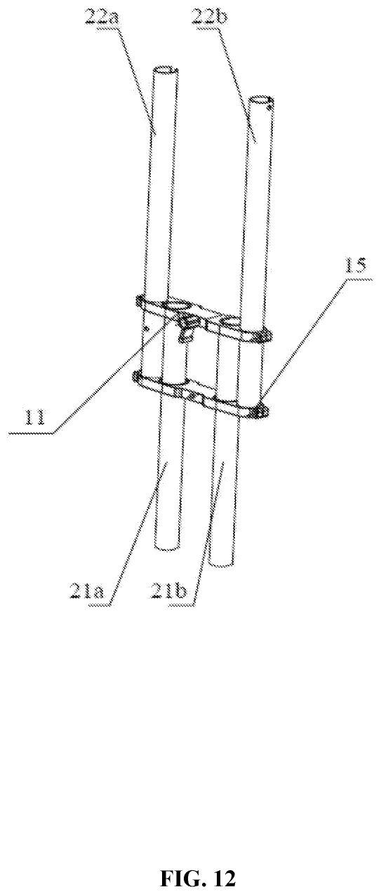

In addition, when there are multiple support rods in the support frame, two first support rods 21 may be disposed between two second support rods 22. FIG. 12 is a schematic illustration of a connection structure of another support frame according to another embodiment of the present disclosure. As shown in FIG. 12, for the support frame provided by this embodiment, its overall structure and operation principles may be all similar to the support frame of the above-described first embodiment. The differences may include, in the four support rods 2 of this embodiment, two first support rods 21a and 21b are located between two second support rods 22a and 22b. The connection relationship between support rods and the second locking frame 15 that is configured to provide guide for and limit the position of the support rods is different from that of the above-described embodiments. Specifically, two through holes on the first locking frame 11 adjacent an inner side may be configured to allow the first support rods 21a and 21b to penetrate therethrough, and may be fixedly connected with end portions of the first support rods 21a and 21b. Two through holes located at an outer side may be configured to allow the second support rods 22a and 22b to penetrate therethrough.

In some embodiments, the support rod may be connected with the second locking frame 15. As another example structure of the second locking frame 15, the first support rods 21a, 21b and the second locking frame 15 may be slidably connected through penetrating two through holes located at an inner side of the second locking frame 15. The second support rods 22a, 22b and the second locking frame 15 may be fixedly connected. Specifically, two through holes located at an outer side of the second locking frame 15 may be fixed to end portions of the second support rods 22a and 22b. As such, the second locking frame 15 and the first locking frame 11 may perform position limiting together, thereby avoiding the separation of the support rod from through holes of the first locking frame 11 or the second locking frame 15, without the need of providing a stopping member to stop and limit the position of the support rod.

In some embodiments, the support frame may include a locking assembly and at least two support rods. The locking assembly may include a first locking frame and a locking block. At least two support rods may be disposed on the first locking frame. The first locking frame may slide relative to and along at least one support rod. The at least two support rods may include at least one first support rod and at least one second support rod. The locking block may be configured to be movable in a direction perpendicular to the axial direction of the second support rod and to press rightly on the second support rod, so as to lock the second support rod at a current location relative to the axial direction of the first support rod. In some embodiments, the second locking frame may be fixedly connected with the second support rod, and may be relatively slidably connected with the first support rod. As such, the length of the support frame may change with the relative movement of the support rod, thereby adapting to different support fixing scenes.

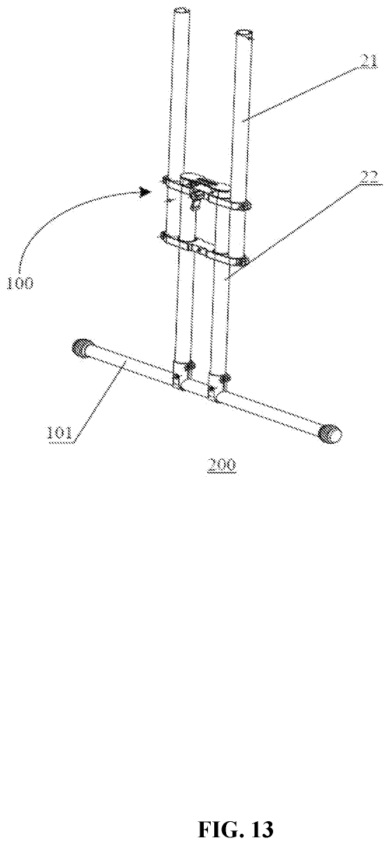

FIG. 13 is a schematic illustration of a structure of a stand assembly according to another embodiment of the present disclosure. As shown in FIG. 13, the present disclosure provides a stand assembly 200 implemented in a UAV, including a support base 101 and a support frame 100 as described herein. At least one of the first support rod 21 or the second support rod 22 of the support frame 100 may be connected with the support base 101.

Specifically, the support base 101 of the stand assembly 200 may include a sturdy support structure, and may be placed on the ground or other supporting plane. The support rod from the first support rod 21 or the second support rod 22 of the support frame 100 that is not connected with the support base 101 may be connected with a structure on the UAV, in order to support the UAV. In some embodiments, the relative locations of the first support rod 21 and the second support rod 22 of the support frame 100 in the axial direction may change, to adjust the overall length of the support frame 100, thereby adapting to different application requirements.

In some embodiments, the stand assembly may include a support base and a support frame. At least one of the first support rod or the second support rod of the support frame may be connected with the support base. The support frame may include the locking assembly and at least two support rods. The locking assembly may include a first locking frame and a locking block. The at least two support rods may be disposed on the first locking frame. The first locking frame may be slidable relative to and along at least one support rod. The at least two support rods may include at least one first support rod and at least one second support rod. The locking block may be configured to be movable in a direction perpendicular to the axial direction of the second support rod and to press tightly on the second support rod, so as to lock the second support rod at the current location relative to the axial direction of the first support rod. As such, the overall length or height of the stand assembly may change with the relative movement of the support rod, thereby adapting to different supporting and fixing scenes.

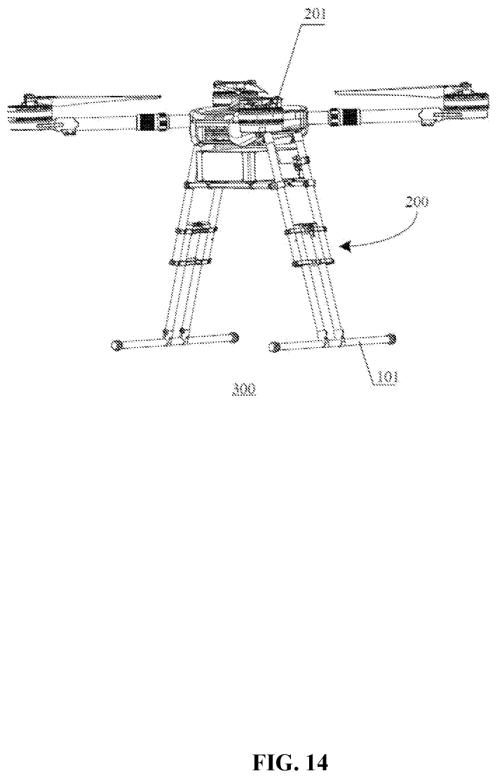

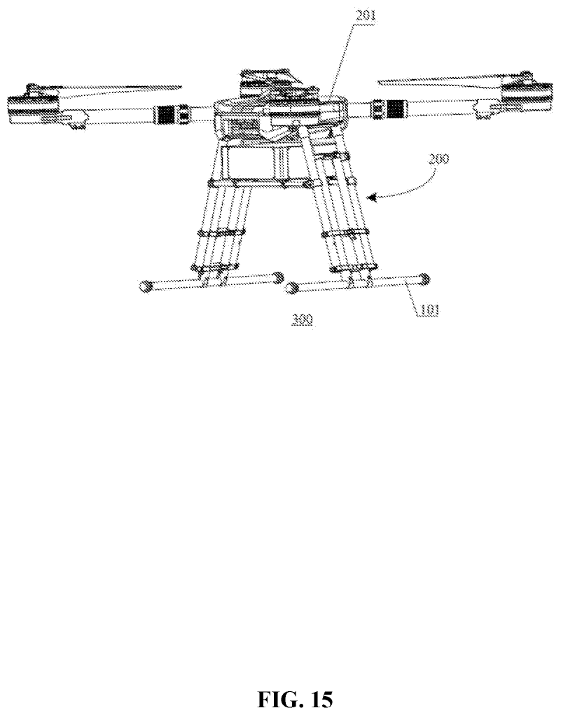

FIG. 14 is a schematic illustration of a structure of the UAV when the stand assembly is in a substantially extended state according to an embodiment of the present disclosure. FIG. 15 is a schematic illustration of a structure of the UAV when the stand assembly is in a substantially retracted state, according to an embodiment of the present disclosure. As shown in FIG. 14 and FIG. 15, the UAV 300 provided by this embodiment may include an aircraft body 201 and a stand assembly 200 as described herein. In the stand assembly 200, the support rod that is not connected with the support base 101 may be connected with the aircraft body 201.

In some embodiments, one of the first support rod or the second support rod of the stand assembly 200 may be connected with the support base 101, and the other may be connected with the machine frame or the aircraft body 201 of the UAV, thereby realizing support for the UAV 300. Because the length of the support frame of the stand assembly 200 may be adjusted, the height of the aircraft body 201 from the ground when the UAV 300 rests on the ground may be changed, thereby adapting to the mounting and use of loads of different dimensions on the aircraft body 201, avoiding the loads scratching with the ground due to the height of the stand assembly 200 being excessively low.

In some embodiments, the UAV may include the aircraft body and the stand assembly. The support rod in the stand assembly that is not connected with the support base may be connected with the aircraft body. The support frame of the stand assembly may include a locking assembly and at least two support rods. The locking assembly may include a first locking frame and a locking block. At least two support rods may be disposed on the first locking frame. The first locking frame may be slidable along at least one support rod. The at least two support rods may include at least one first support rod and at least one second support rod. The locking block may be configured to be movable in the direction perpendicular to the axial direction of the second support rod and to press tightly on the second support rod, so as to lock the second support rod at the current location relative to the axial direction of the first support rod. As such, the height of the UAV from the ground, i.e., the height of the stand, may change with the relative movement of the support rod, thereby adapting to different loads and aircraft body dimensions.

Finally, it should be noted that: the above various embodiments are merely used to describe the technical solutions of the present disclosure, and are not to limit the present disclosure. A person having ordinary skills in the art can appreciate that the technical solution of the above described various embodiments may be modified or equivalently substituted with respect to some or all of the technical features. Such modification or substitution does not render the relative technical solution deviating from the scope of the technical solution of the various embodiments of the present disclosure.

What is claimed is:

1. A support frame, comprising:
a locking assembly including a first locking frame and a locking block; and
at least two support rods disposed on the first locking frame, the at least two support rods including at least one first support rod and at least one second support rod,
wherein the first locking frame is slidable relative to and along at least one of the support rods, and
wherein the locking block is configured to be movable in a direction perpendicular to an axial direction of the second support rod and to press tightly on the second support rod, to lock the second support rod at a current location relative to an axial direction of the first support rod.

2. The support frame according to claim 1,
wherein the first locking frame is provided with at least one through hole,
wherein the second support rod corresponds to the through hole one on one and penetrates the through hole,
wherein a wall of the through hole includes a through groove,
wherein the locking block is located in the through groove, and is movable in a cross-sectional direction of the through hole relative to the first locking frame, and to lock at at least one location in the cross-sectional direction of the through hole, and wherein the locking block is configured to tightly press, together with the wall of the through hole opposite the through groove, the second support rod at the current location in the axial direction.

3. The support frame according to claim 2, further comprising a nylon sleeve tube having a variable diameter,
wherein the nylon sleeve tube is disposed in the through hole where the second support rod is located, and the locking block is configured to tightly press an outer side of the nylon sleeve tube, to tightly press the second support rod at the current location in the axial direction.

4. The support frame according to claim 2, wherein the locking block includes an arc shaped surface matching with a shape of a rod body of the second support rod.

5. The support frame according to claim 1,
wherein the locking assembly includes a connecting member connecting between the locking block and the first locking frame,
wherein the connecting member is movable in a cross-sectional direction of the through hole relative to the first locking frame and is configured to lock at at least one location in the cross-sectional direction of the through hole, and
wherein the connecting member is configured to cause the locking block to move in the cross-sectional direction of the through hole and to tightly lock.

6. The support frame according to claim 5,
wherein the connecting member includes a screw and a protrusion portion,
wherein the locking block and the first locking frame both include a through hole matching with the screw, and one of the through hole of the locking block and the through hole of the first locking frame is a threaded hole, the other one is a smooth hole,
wherein the screw is configured to penetrate the through holes of the locking block and the first locking frame, to connect with threads of the threaded hole, and
wherein the protrusion portion is configured to abut against the smooth hole of the through holes of the locking block or the first locking frame.

7. The support frame according to claim 1, further comprising:
a second support frame provided with at least one through hole,
wherein one of the first support rod and the second support rod is fixedly connected with the second locking frame, the other one is configured to penetrate the through hole to slidably connect with the second locking frame.

8. The support frame according to claim 1, wherein the support rod includes four support rods, and wherein the four support rods include two of the first support rods and two of the second support rods.

9. The support frame according to claim 8, wherein the second support rods are disposed between the two of the first support rods, or the first support rods are disposed between the two of the second support rods.

10. A stand assembly for an unmanned aerial vehicle (“UAV”), comprising:
a support base; and
a support frame including a locking assembly and at least two support rods
wherein the locking assembly includes a first locking frame and a locking block,
wherein the at least two support rods are disposed on the first locking frame, and include at least one first support rod and at least one second support rod,
wherein the first locking frame is slidable along and relative to at least one of the support rods,
wherein the locking block is configured to be movable in a direction perpendicular to an axial direction of the second support rod, to lock the second support rod at a current location relative to an axial direction of the first support rod, and
wherein at least one of the first support rod or the second support rod of the support frame is connected with the support base.

11. The stand assembly according to claim 10,
wherein the first locking frame is provided with at least one through hole,
wherein the second support rod corresponds to the through hole one on one and is configured to penetrate the through hole,
wherein a wall of the through hole is provided with a through groove,
wherein the locking block is located in the through groove,
wherein the locking block is movable in a cross-sectional direction of the through hole relative to the first locking frame and is configured to lock at at least one location in the cross-sectional direction of the through hole, and
wherein the locking block is configured to tightly press, together with the wall of the through hole opposite the through groove, the second support rod at the current location in the axial direction.

12. The stand assembly according to claim 11, further comprising:
a nylon sleeve tube having a variable diameter and disposed in the through hole where the second support rod is located,
wherein the locking block tightly is configured to press an outer side of the nylon sleeve tube, to tightly press the second support rod at the current location in the axial direction.

13. The stand assembly according to claim 11, wherein the locking block includes an arc shaped surface matching with a shape of a rod body of the second support rod.

14. The stand assembly according to claim 10,
wherein the locking assembly includes a connecting member connecting between the locking block and the first locking frame,
wherein the connecting member is movable in a cross-sectional direction of the through hole relative to the first locking frame and is configured to lock at at least one location in the cross-sectional direction of the through hole, and
wherein the connecting member is configured to cause the locking block to move in the cross-sectional direction of the through hole and to lock tightly.

15. The stand assembly according to claim 14,
wherein the connecting member includes a screw and a protrusion portion,
wherein the locking block and the first locking frame both include a through hole matching with the screw, and one of the through hole of the locking block and the through hole of the first locking frame is a threaded hole, the other one is a smooth hole,
wherein the screw is configured to penetrate the through holes of the locking block and the first locking frame, to connect with threads of the threaded hole, and
wherein the protrusion portion is configured to abut against the smooth hole of the through holes of the locking block or the first locking frame.

16. The stand assembly according to claim 10, further comprising:
a second support frame provided with at least one through hole, wherein one of the first support rod and the second support rod is fixedly connected with the second locking frame, the other one is configured to penetrate the through hole to slidably connect with the second locking frame.

17. The stand assembly according to claim 10, wherein the support rod includes four support rods, and wherein the four support rods include two of the first support rods and two of the second support rods.

18. The stand assembly according to claim 17, wherein the second support rods are disposed between the two of the first support rods, or the first support rods are disposed between the two of the second support rods.

19. An unmanned aerial vehicle (“UAV”), comprising:
an aircraft body; and
a stand assembly including a support base and a support frame,
wherein the support frame includes a locking assembly and at least two support rods,
wherein the locking assembly includes a first locking frame and a locking block,
wherein the at least two support rods are disposed on the first locking frame,
wherein the first locking frame is slidable along and relative to at least one of the support rods,
wherein the at least two support rods include at least one first support rod and at least one second support rod,
wherein the locking block is configured to be movable in a direction perpendicular to an axial direction of the second support rod and to press tightly on the second support rod, to lock the second support rod at a current location relative to an axial direction of the first support rod,
wherein at least one of the first support rod or the second support rod of the support frame is connected with the support base, and
wherein in the stand assembly, the support rod not connected with the support base is connected with the aircraft body.

20. The UAV according to claim 19,
wherein the first locking frame is provided with at least one through hole,
wherein the second support rod corresponds to the through hole one on one and is configured to penetrate the through hole,
wherein a wall of the through hole includes a through groove,
wherein the locking block is located in the through groove, and is movable in a cross-sectional direction of the through hole relative to the first locking frame and is configured to lock at at least one location in the cross-sectional direction of the through hole, and
wherein the locking block is configured to tightly press, together with the wall of the through hole opposite the through groove, the second support rod at the current location in the axial direction.
